(19) United States
(12) Patent Application Publication
(10) Pub. No.: US 2009/0011216 A1
(43) Pub. Date: Jan. 8, 2009

(54) FOAMED LIQUID MOLDING RESIN

(76) Inventors: Youji Suzuki, Chiba (JP); Takeshi Kato, LaPorte, TX (US)

Correspondence Address: FITZPATRICK CELLA HARPER & SCINTO, 30 ROCKEFELLER PLAZA, NEW YORK, NY, 10112, US

(21) Appl. No.: 11/772,506

(22) Filed: Jul. 2, 2007

(51) Int. Cl. B32B 5/18

(52) U.S. Cl. 428/308.4; 106/122; 264/51; 264/54

(57) ABSTRACT

A method of making a molded resin product includes the steps of (i) providing a plurality of liquid resin components that each include a reaction monomer for a resin, wherein at least one of the liquid resin components includes a catalyst, at least one of the liquid resin components includes an activator, and at least one of the liquid resin components includes thermally expandable microspheres, (ii) mixing the liquid resin components; and (iii) injecting the mixed liquid resin components into a mold at a predetermined temperature. The predetermined temperature is at least 10° C. lower than an expansion start temperature of the thermally expandable microspheres.

### BACKGROUND OF THE INVENTION

1. Field of the Invention

The present invention relates to a liquid molding resin and, more particularly, to a liquid resin for use in reaction injection molding.

2. Description of the Related Art

A process is known for forming molded articles using thermoset polymers such as, for example, lightly cross-linked thermoset polymers based on polydicyclopentadiene (poly-DCPD or PDCPD). In such a process, two (or more) DCPD liquid streams are mixed together at a temperature near room temperature and are injected into a closed mold. One of the streams contains an activator and the other stream contains a catalyst. When the streams are mixed together, an exothermic reaction occurs (a polymerization crosslinking reaction) and a fully polymerized product is created.

There are two principal problems exhibited by PDCPD molded resin products. The first problem is that the surface of the molded resin is rough because the PDCPD shrinks during molding. Shrinkage may be about 4% by volume, and such shrinkage creates shrinkage cavities and filling defects. If these defects occur on the surface, the surface quality decreases significantly and secondary processing (such as filling with putty and polishing) is needed to improve surface quality, which increases labor and cost.

The second problem is that the specific gravity of PDCPD is about 1.034 g/cm³, which is generally heavier than that of other resins. A lower specific gravity is desirable, especially in the case of large and/or thick parts, to reduce overall weight.

Efforts have been made by others to address these problems. Regarding the first problem, one prior art approach to solving the problem of surface roughness will be explained with respect to FIG. 4. As shown in FIG. 4, a reservoir 100 and a reservoir 200 respectively contain Component A and Component B for forming a molded resin product. Component A and Component B are liquid resins, one of which contains a catalyst and the other of which contains an activator. As shown, the two reservoirs provide respective streams to a Mix Head 400. If needed for the particular resin being used, a reservoir 300 may be provided to supply a third component, Component C. The mixed liquid resin is then injected into a mold 500 that has a cavity side 510 and a core side 520. As a result of the exothermic reaction within the mold, a molded resin product 600 is formed.

According to one prior art approach to solving the surface roughness problem, the molded resin thickness is set to about 2-3 mm (at most about 5 mm), and a temperature gradient is established to create a temperature difference between the cavity side of the mold and the core side of the mold. In particular, a temperature gradient is established so that the cavity side 510 is at a higher temperature than the core side 520. Using this technique, the shrinkage cavities and defects are concentrated on the core side of the molded resin, and a smooth surface can be obtained on the cavity side of the molded resin. Alternatively, a mold release agent may be coated on the inner surface of the cavity side mold 510, which achieves a similar result in that defects are concentrated at the core side of the molded resin.

However, the conventional technique shown in FIG. 4 leaves room for improvement. The method does not work well for molding thick sections such as ribs and bosses. Further, the filling ability is poor, and it is difficult to obtain molded resin of stable quality and high dimensional accuracy. Accordingly, thick portions must be molded separately and attached, or the thickness must be gradually increased in zones that are not visible to avoid abrupt thickness changes. The former approach requires troublesome secondary processing to attach separate parts, while the latter approach places limitations on the shape and location of thick resin portions. Thus, the temperature gradient technique does not adequately address the surface quality problem. Moreover, this technique is merely focused on achieving a smooth surface on the cavity side of the molded resin, and does not address the roughness on the core side surface. Therefore, even when the temperature gradient technique is applied, the resulting PDCPD molded resin still has a rough surface on the core side and cannot be used for applications where external smoothness and appearance are important for both surfaces.

Regarding the second problem, one prior art approach to solving the problem of heavy specific gravity will be explained with respect to FIGS. 5 and 6. As shown in FIG. 5, this technique also uses reservoir 100, reservoir 200, mix head 400, mold 500, and (optionally) reservoir 300. This technique involves either adding a chemical foaming agent or a dissolved gas (such as nitrogen) to at least one of the resin components (i.e., Component A, Component B, and/or, if used, Component C). With this technique, a molded resin product 700 can be obtained that has a lighter specific gravity than would otherwise be obtained using PDCPD resin. However, the molded resin product 700 obtained using this conventional technique has some drawbacks: the size of the obtained gas bubbles may be too large, foaming becomes non-uniform, mechanical properties are degraded, shrinkage appears in the product, and the external appearance is deteriorated.

FIG. 6 shows a cross-section of molded resin product 700. As shown in FIG. 6, the molded resin includes numerous gas bubbles or foaming agent cells 800 (depending on whether a foaming agent or dissolved gas was added to one or more resin components). However, the size of many gas bubbles or foaming agent cells is too large, and some of the gas bubbles or foaming agent cells 800 exhibit an open cell structure. In addition, some gas bubbles or foaming agent cells are located at the surface of the molded resin. As a result, the mechanical properties of molded resin product 700 are not good, and the surface condition of the product is not good.

A variation of the conventional technique shown in FIG. 5 has also been studied. In this variation, a gas such as nitrogen is dissolved in one or more components of the liquid resin and, after the resin is mixed and injected into a mold, the pressure inside the mold is reduced to gassify the dissolved nitrogen. Examples of this technique are disclosed in Japanese Laid-open Patent Application No. 2003-040984; Japanese Laid-open Patent Application No. 2003-291864; and Japanese Laid-open Patent Application No. 2004-168914.

However, this variation also suffers drawbacks. If a high pressure is maintained during molding, foaming ability and filling ability are degraded. On the other hand, if low pressure is maintained, the obtained gas bubbles are large and non-uniform in size, shrinkage occurs, and mechanical strength is decreased because of an open-cell structure. It is difficult to obtain uniform gas bubbles with good reproducibility, because the condition of the gas bubbles varies significantly with even minor pressure fluctuations. Also, because foaming occurs on the surface, pin holes or other defects can appear on the molded resin surface that degrade the external appearance.

In addition to physical drawbacks of molded resin made using this technique, there are also economic drawbacks. Dissolving a gas such as nitrogen to be added to a liquid resin component must be performed under high pressure. It is expensive to add high-pressure gas injection equipment to the system of FIG. 5, and to modify the other equipment for operation under high pressure. Thus, aside from the issues of mechanical properties and surface condition, this technique is not practical for commercial production due to economic reasons.

Yet another method that has been studied to reduce the specific gravity of a foamed molded resin involves using thermally expandable microspheres. An example of this technique is disclosed in Japanese Laid-open Patent Application No. H7-178756. In this technique, only an inner layer is foamed. More specifically, a third liquid resin component that contains a foaming agent such as thermally expandable microspheres is prepared and is injected into a mold during an intermediate or final stage of injecting the first two mixed components.

The present inventors have observed several problems with this technique. First, the thermally expandable microspheres may not be expanded properly. When thermally expandable microspheres are used in a thermosetting resin, the expansion of the thermally expandable microspheres must be induced at either a liquid stage before curing is started or at a stage when viscosity is increased by the advancement of the polymerization crosslinking reaction. Therefore, the expansion start temperature of the thermally expandable microspheres is selected to match the curing initiation temperature of the resin. In the case of reaction injection molding of dicyclopentadiene, the mold temperature is usually within a range from about room temperature to about 100° C. Accordingly, thermally expandable microspheres having an expansion start temperature of 100° C. or less have been used. However, thermally expandable microspheres having an expansion start temperature of 100° C. or less have a highest expansion temperature of about 140-150° C. If such microspheres are heated above that highest expansion temperature, the expanded microspheres may shrink or collapse. Since, in the case of reaction injection molding of dicyclopentadiene, the temperature of the molded resin often increases above 200° C. due to heat generated during the reaction, some of the microspheres will not be expanded properly and the expansion ratio will be decreased.

Another problem with this technique is that the formulation of the third liquid resin component, containing the microspheres, is different from that of the other two liquid resin components, respectively containing a catalyst and an activator. When the third component is injected into the mixture of the first two components, those other components will be diluted and the concentrations of the catalyst and the activator fluctuate. This causes a difference in the reaction sped within the mold, and regions of strain appear within the molded resin. Also, since the ratio between the portion of liquid resin containing microspheres and the portion of liquid resin not containing microspheres fluctuates as the injected liquid resin flows inside the mold, it is difficult to obtain with good reproducibility a uniform surface layer not containing expanded microspheres across the entire surface of the molded resin. In particular, in molded resin having thick portions or portions with non-uniform thickness, the fluctuations of liquid resin with the mold are especially large and a molded resin having a uniform surface layer is especially difficult to obtain.

Yet another problem with this technique is that it requires special molding equipment to enable the injection of the third component with an injection timing controlled to a precision of 0.1 second. Such equipment is expensive.

Accordingly, another solution is needed to produce molded resin products having a lower specific gravity and having a smooth surface condition on both surfaces, as well as good mechanical properties.

### SUMMARY OF THE INVENTION

The present invention is directed to liquid molding resin components and a liquid molding process that can produce molded resin products having a smooth surface on both the core side and cavity side surfaces of the molded resin product, along with desirable mechanical properties. The inventors have found that an improved molded resin product can be formed by adding thermally expandable microspheres to at least one liquid resin component, where the microspheres have an expansion start temperature that is substantially higher than the temperature of the mold.

Accordingly, one aspect of the present invention is directed to a liquid molding resin component for mixing with at least one other liquid resin component prior to injection into a mold at a predetermined temperature, the liquid molding resin component comprising a liquid resin, one of an activator or a catalyst, and a plurality of thermally expandable microspheres having an expansion start temperature substantially higher than the temperature of the mold.

According to yet another aspect, the present invention is directed to a liquid resin component system comprising a plurality of liquid resin components that are maintained separately prior to being mixed and injected into a mold at a predetermined temperature, wherein at least one of the liquid resin components includes a catalyst and at least one of the liquid resin components includes an activator, and wherein at least one of the liquid resin components includes thermally expandable microspheres having an expansion start temperature that is substantially higher than the temperature of the mold.

According to still another aspect, the present invention is directed to a method of making a liquid resin component for mixing with at least one other liquid resin component and injecting into a mold at a predetermined temperature, the method comprising the steps of providing a liquid resin, adding one of a catalyst or an activator to the liquid resin, and adding thermally expandable microspheres to the liquid resin, wherein the thermally expandable microspheres have an expansion start temperature that is substantially higher than the temperature of the mold.

Yet another aspect of the present invention is directed to a method of making a molded resin product, the method comprising the steps of providing a first liquid resin component including a catalyst, providing a second liquid resin component including an activator, mixing the first and second liquid resin components, and injecting the mixed liquid resin components into a mold having a predetermined temperature, wherein at least one of the first liquid resin component and the second liquid resin component contains thermally expandable microspheres having an expansion start temperature that is substantially higher than the temperature of the mold.

Still another aspect of the present invention is directed to a molded resin product formed by a method comprising the steps of providing a first liquid resin component including a catalyst, providing a second liquid resin component including an activator, mixing the first and second liquid resin components, and injecting the mixed liquid resin components into a mold having a predetermined temperature, wherein at least one of the first liquid resin component and the second liquid resin component contains thermally expandable microspheres having an expansion start temperature that is substantially higher than the temperature of the mold.

These and other aspects of the present invention will be described in further detail below, with reference to the accompanying drawings.

### BRIEF DESCRIPTION OF THE DRAWINGS

FIG. 1 shows a system for making a molded resin product according to a preferred embodiment of the present invention.

FIG. 2 shows a process for making a molded resin product in accordance with a preferred embodiment of the present invention.

FIG. 3 depicts a cross-section of a molded resin product made in accordance with a preferred embodiment of the present invention.

FIG. 4 shows a prior art system for making a molded resin product having a smooth surface.

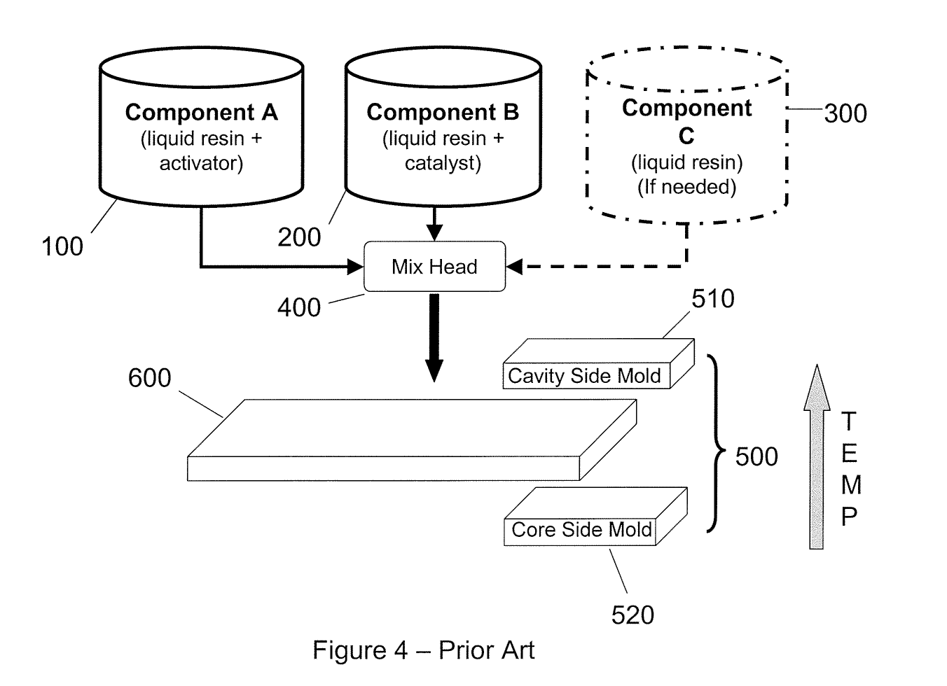

FIG. 5 shows a prior art system for making a molded resin product having a lighter specific gravity.

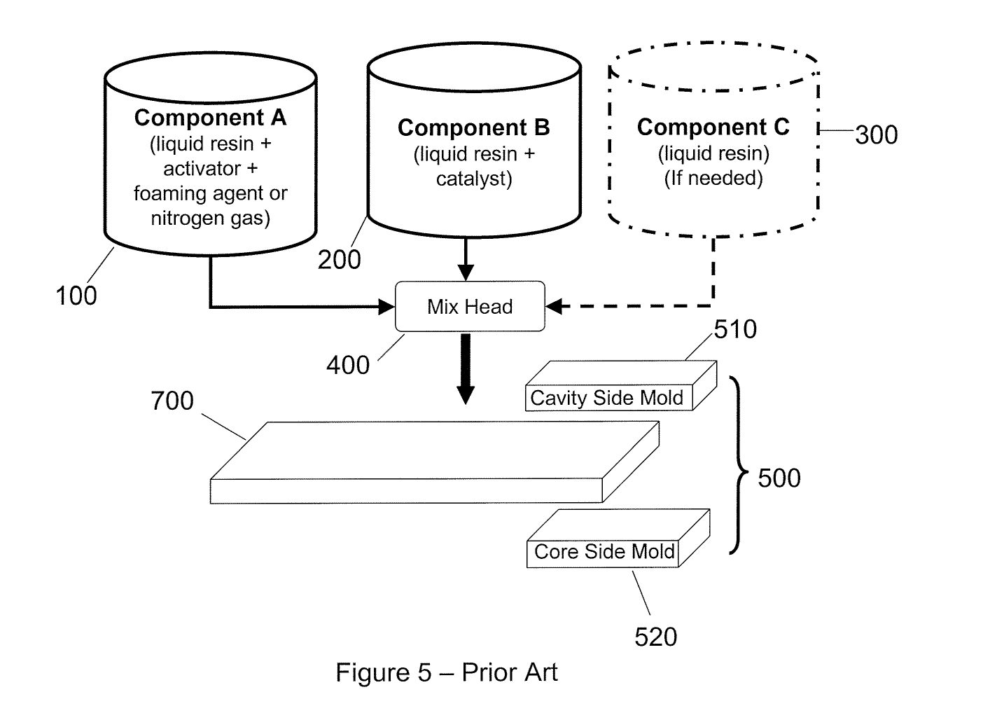

FIG. 6 depicts a cross-section of a molded resin product made in accordance with the system of FIG. 5.

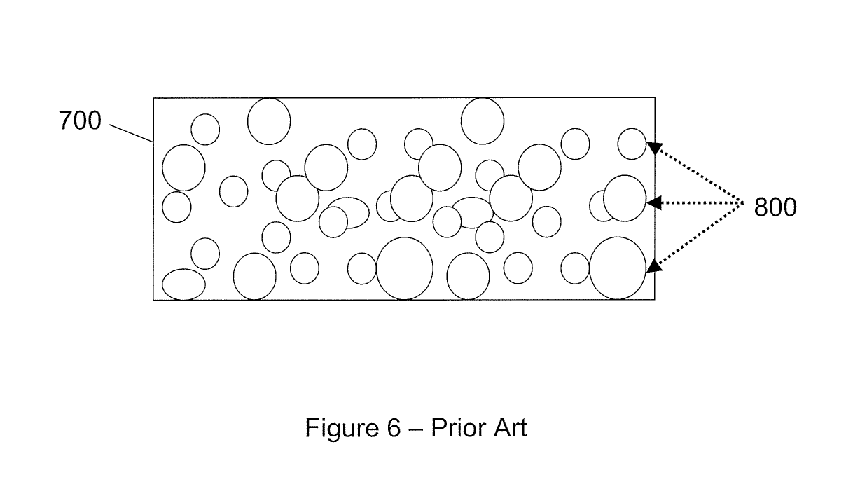

### DETAILED DESCRIPTION OF THE PREFERRED EMBODIMENTS

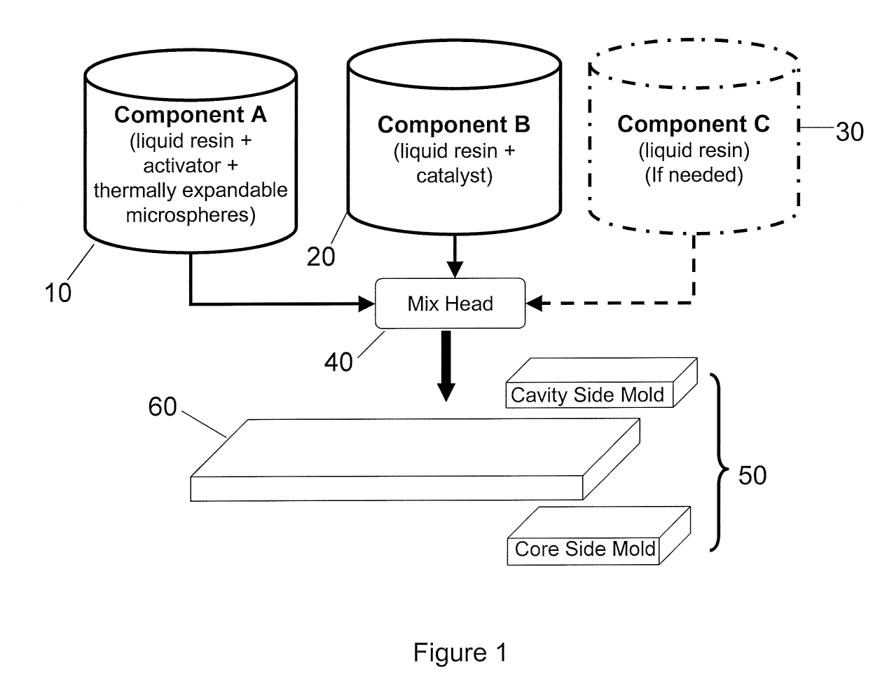

As shown in FIG. 1, a system for making a molded resin product according to a preferred embodiment of the invention includes a reservoir 10 (containing Component A), a reservoir 20 (containing Component B), a mix head 40, and a mold 50. Optionally, a reservoir 30 (containing Component C) may also be included.

Each of the reservoirs 10 and 20 (and reservoir 30, if used) includes a liquid resin component. The liquid resin component is a reaction monomer of a thermoset polymer, preferably a crosslinked olefinic thermoset polymer. Most preferably, the liquid resin components are based on dicyclopentadiene and, when reacted together, form a polydicyclopentadiene (PDCPD) resin.

As mentioned above, the preferred embodiment uses dicyclopentadiene as a liquid resin component (i.e., a reaction monomer). The dicyclopentadiene may be used as the sole reaction monomer or in a mixture with other reaction monomers containing a norbornene structure. Other reaction monomers that can be used together with dicyclopentadiene may include, for example, norbornene, methyl norbornene, ethyl norbornene, 5-ethylidene norbornene, dimethanohexahydronaphthalene, dimethanooctahydronaphthalene, and tricyclopentadiene. When a reaction monomer other than dicyclopentadiene is used in the mixture, the content ratio of dicyclopentadiene in the reaction monomer mixture is preferably 70 mol. % or more, and more preferably 80 mol. % or more.

At least one of the liquid resin components (e.g., Component A) includes an activator. The activator is preferably an organometallic compound, such as an alkylated metal of groups I to III of the periodic table of elements. For example, the activator may be an alkylaluminum compound such as trioctylaluminum, or an alkylaluminum halide compound such as diethylaluminum chloride, ethylaluminum dichloride, and dioctylaluminum iodide, or a tetralkyltin compound such as tetrabutyltin. Component A is prepared by dissolving the organometallic compound used as an activator into dicyclopentadiene.

When an alkylaluminum is used as the activator, the weight ratio of the aluminum compound based on the total amount of dicyclopentadiene, or dicyclopentadiene mixed with other reaction monomers, in Component A is within a range of about 1:10 to 1:1,000, and preferable within a range of about 1:40 to 1:200.

At least one of the other liquid resin components (e.g., Component B) includes a catalyst. The catalyst is preferably a halide or metal ammonium salt of metals such as tungsten, rhenium, tantalum, and molybdenum. From the standpoint of reactivity, tungsten compounds are especially preferred. Among tungsten compounds, preferred examples of a catalyst include tungsten hexahalides such as tungsten hexachloride and tungsten oxyhalides such as tungsten oxychloride. Further, an organic ammonium salt of tungstic acid may also be used.

When a tungsten compound is used as the catalyst, the volume ratio of the tungsten compound based on the total amount of dicyclopentadiene (or dicyclopentadiene mixed with other reaction monomers) in Component B is preferably within a range of about 1:5 to 1:500 and, more preferably, within a range of about 1:20 to 1:100.

If a tungsten compound such as those mentioned above is added directly to the dicyclopentadiene, cationic polymerization is immediately initiated. Therefore, when Component B is prepared using such a tungsten compound, the catalyst has to be deactivated in advance. More specifically, it is preferred that these tungsten compounds are prepared for use by suspending the compound in an appropriate inactive solvent such as, for example, benzene, toluene, and chlorobenzene, and adding a small amount of an alcohol-based compound and/or a phenol-based compound to the inactive solvent. Further, it is preferable that about 1-5 mol of Lewis base or a chelating agent be added to 1 mol of the tungsten compound in order to prevent the cationic polymerization. Examples of suitable additives include acetylacetone, alkyl esters of alkyl acetate, tetrahydrofuran, and benzonitrile. The amount of chelating agent or the like can be appropriately selected according to the amount of the catalyst.

Further, with the above-described preferred composition, the polymerization reaction proceeds rapidly and may therefore be completed before the liquid resin flows in a sufficient amount into the mold. Accordingly, it is preferable to use a regulating agent to regulate the polymerization activity. A Lewis base is preferably used as such a regulating agent, and ethers, esters, and nitrites are especially preferred. Specific examples of preferred compounds for uses as regulating agents include ethyl benzoate, butyl ether, and diglyme. These regulating agents are preferably used by adding the compound to Component A containing an organometallic compound as an activator, and the amount of the regulating agent is appropriately selected according to the amount of the catalyst being used.

The optional Component C is preferably also a dicyclopentadiene liquid resin containing neither an activator or a catalyst. Thermally expandable microspheres can be added to Component C instead of, or in addition to, adding them to Component A and/or Component B.

Each of Component A, Component B, and (if used) Component C may also include other additives to improve or maintain the properties of the molded resin. For example, such additives may serve as fillers, pigments, antioxidants, photostabilizers, flame retardants, or polymer conditioners.

Other polymer components may also be added to the liquid resin components. For example, elastomers are often used as polymer additives to increase the impact strength of the molded resin and to control the viscosity of the liquid resin. Specific examples of preferred elastomers include styrene-butadiene-styrene block rubber, styrene-isoprene-diene-terpolymer, nitrile rubber, a styrene block rubber, polybutadiene, polyisoprene, butyl rubber, ethylene-propylene-diene-terpolymer, and nitrile rubber.

At least one of the liquid resin components also includes thermally expandable microspheres that start expansion at or about a specific temperature. The expansion start temperature should be substantially higher than the temperature of mold 50 into which the liquid resin will be injected. Preferably, the expansion start temperature is at least about 10° C. or more higher than the injection temperature of the mold, preferably 20° C. or more higher, and most preferably 30° C. or more higher. If the mold temperature is not at least about 10° C. lower than the expansion start temperature, expansion of the thermally expandable microspheres may occur in the vicinity of the molded resin surface due to heating from the mold. This is undesirable because it is preferred to have a layer containing substantially no expanded microspheres near the surface of the molded resin. In the preferred embodiment, when the liquid resin components are based on dicyclopentadiene, the mold temperature is preferably within a range of about 20-120° C., and more preferably within a range of about 40-100° C.

The thermally expandable microspheres preferably have a core-shell structure in which a low-boiling hydrocarbon is enclosed in a thermoplastic polymer shell, for example, acrylonitrile, vinylidene chloride, etc. When the thermally expandable microspheres are heated, the thermoplastic polymer shell is softened and the low-boiling hydrocarbon enclosed therein (which boils at a temperature below that at which the polymer shell softens) is simultaneously expanded, whereby hollow balloons are formed. The thermally expandable microspheres form a fine, closed-cell structure with good stability in the foamed molded resin.

The expansion start temperature of the thermally expandable microspheres means the temperature at which the thermoplastic polymer shell is softened by heating so that the microspheres begin expanding as the enclosed hydrocarbon boils. The expansion start temperature is preferably in the range of about 120° C. to 160° C., particularly when the liquid resin components (i.e., reaction monomers) are based on dicyclopentadiene, for the following reasons. If the expansion start temperature is above about 160° C., the crosslinking polymerization reaction of dicyclopentadiene proceeds before the expansion begins. As a result, the crosslinked polymer of dicyclopentadiene that has already been formed before the start of expansion inhibits the expansion, and a sufficient expansion of the microspheres cannot be obtained. On the other hand, if the expansion start temperature is less than about 120° C., then the maximum expansion temperature will be relatively low and the thermally expandable microspheres will shrink and/or collapse before the crosslinking polymerization reaction of the dicyclopentadiene proceeds to a sufficient degree. As a result, the shape of the expanded microspheres is difficult to maintain.

When dicyclopentadiene is used as the basis of the liquid resin components, the maximum expansion temperature of the thermally expandable microspheres is preferably 150° C. or higher, and more preferably 160° C. or higher. The maximum expansion temperature of the microspheres means the temperature at which the microspheres exhibit no further increase in size, and perhaps start to shrink, even if they are heated to a higher temperature. As mentioned above, the temperature of the molded resin can exceed 200° C. during reaction molding, due to heat generated by the reaction. However, the inventors have observed that if the maximum expansion temperature is 150° C. or higher when polymerizing dicyclopentadiene, the crosslinked polymer of dicyclopentadiene is sufficiently organized before the microspheres start to shrink that the shape of the expanded microspheres can be adequately maintained.

The size (i.e., average diameter) of the expanded microspheres is preferably 100 μm or less. For example, if thermally expandable microspheres are used that have an expansion factor of about 2 under molding conditions, then the average microsphere diameter prior to expansion is preferably about 10-50 μm.

There is no specific limitation on the amount of thermally expandable microspheres that may be added to Component A, Component B, and/or Component C, provided that the thermally expandable microspheres can be uniformly dispersed in the liquid resin. However, the total amount of the thermally expandable microspheres in all the liquid resin components is preferably within the range from about 0.1 to about 5 parts by weight of the total amount of liquid resin used in the molding process (that is, the liquid resin after mixing of the components). More preferably, the total amount of thermally expandable microspheres is in the range of about 0.2 to about 2 parts by weight of the total amount of liquid resin. If the amount of microspheres is less than 0.1 parts by weight, the effects usually provided by the expanded microspheres, such as improved filling ability during molding and the prevention of shrinkage cavities in the molded resin, will not be obtained. On the other hand, if the amount of microspheres is greater than about 5 parts by weight, the number of expanded microspheres in the molded resin will be too great and the mechanical properties will be adversely affected.

One skilled in the art will appreciate that some variation in the expansion start temperature, the maximum expansion temperature, the weight percentage of the microspheres, and the expanded microspheres size is possible, depending on the particular reaction monomers used for the liquid resin. It is preferable that the values of those parameters be such that the expanded microspheres have a closed cell structure and the molded resin product has a layer at the surface that contains substantially no expanded microspheres.

As specific examples of suitable thermally expandable microspheres, commercially-available products such as the ADVANCELL EM series (manufactured by Sekisui Chemical Co., Ltd.), Matsumoto MICROSPHERES F series (manufactured by Matsumoto Yushi-Seiyaku Co., Ltd.), and EXPANCEL series (manufactured by Expancel Inc.) may be used.

It is preferable that degassing and/or dewatering be performed for a liquid resin component prior to adding the thermally expandable microspheres to the component. This permits the liquid resin to be stored for a long time and polymerization is not inhibited. Further, the liquid resin components are preferably stored in individual airtight containers to prevent them from coming into contact with each other prematurely. The liquid resins are usually handled under an inactive gas atmosphere because the activator in Component A, in particular, loses its activity.

When injection molding is to be carried out, each of the reservoirs 10, 20, and (if used) 30 provides a liquid stream to the mix head 40. The respective airtight storage containers may serve as the reservoirs, if there is appropriate provision for connection a pump or the like to transfer the liquid resin component to the mix head 40. The liquid resin components are preferably maintained at a temperature in the range of about 20-45° C. Homogeneous premixing is performed by mix head 40.

After the liquid resin components are mixed together by mix head 40, they are injected into mold 50, which is set at a temperature at least about 10° C. lower than the expansion start temperature of the thermally expandable microspheres. An exothermic reaction takes place, which creates a fully polymerized molded resin product 60.

The pressure maintained within the mold during the molding reaction is preferably within a range of about 0-1 MPa, and more preferably within a range of about 0.02-0.5 MPa, so as to prevent excess expansion of the thermally expandable microspheres and the appearance of voids or the like.

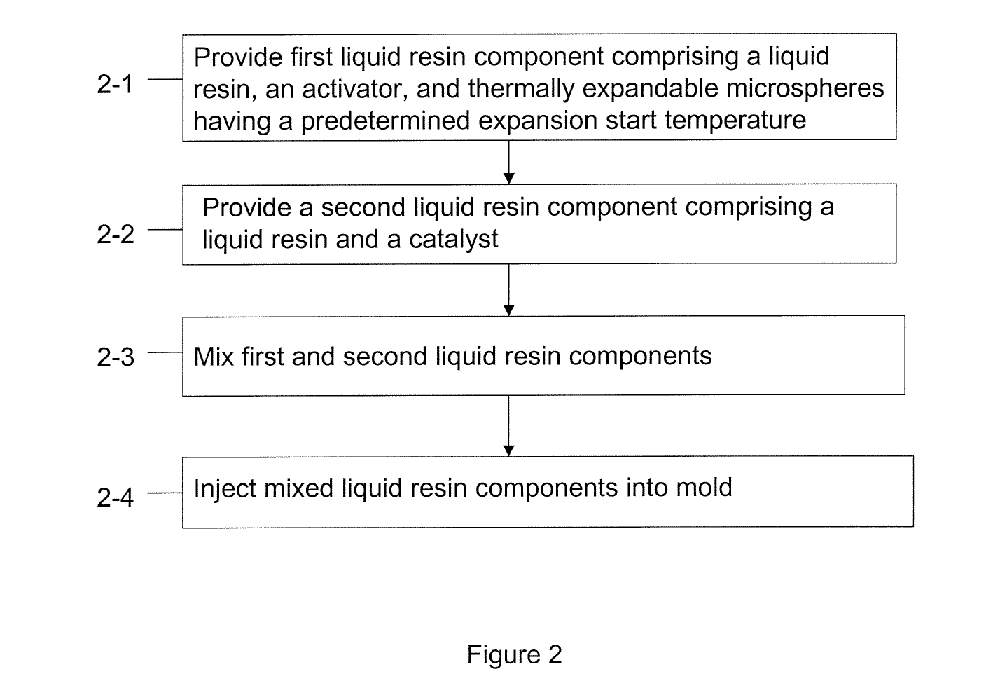

FIG. 2 is a flow diagram illustrating a process for making a molded resin product. In step 2-1, a first liquid resin component is provided that comprises a liquid resin reaction monomer, an activator, and thermally expandable microspheres having a predetermined expansion start temperature. As mentioned above, in the preferred embodiment the microspheres have an expansion start temperature in the range of about 120° C. to about 160° C., the microspheres are provided in an amount such that they constitute about 0.1 to about 5 parts by weight of the total liquid resin following mixture of the liquid resin components, and the expanded microspheres have an average diameter of about 100 μm or less.

In step 2-2, a second liquid resin component is provided that comprises a liquid resin reaction monomer and a catalyst.

In step 2-3, the first and second liquid resin components are mixed together. As mentioned above, the resin components are preferably mixed homogeneously with a 1:1 ratio. In step 2-4, the mixed liquid resin is injected into a mold set to a predetermined temperature. In the preferred embodiment, the liquid resin is injected into a mold at a temperature at least about 10° C. less than the expansion start temperature. An exothermic reaction occurs in the mold, and the liquid resin becomes polymerized (i.e., cured). Thus, as a result of these steps, a molded resin product is formed.

Although in the above description the thermally expandable microspheres are included in the liquid resin component containing the activator, it should be apparent to those skilled in the art that the microspheres could instead be included in the liquid resin component that contains the catalyst, or some microspheres could be included in both liquid resin components. Further, those of ordinary skill in the field of thermoset resins will understand that a third resin component containing liquid resin and microspheres and/or other additives may be used.

The crosslinking polymerization reaction of the liquid resin (e.g., dicyclopentadiene) starts from the mold surface and proceeds toward the inside of the molded resin. By contrast, since the mold temperature is set lower than the expansion start temperature of the thermally expandable microspheres, the expansion of the microspheres starts from inside the molded resin where the heat generated by the crosslinking polymerization reaction easily accumulates, and the expansion proceeds in the direction of the mold surface. As a result, when the mold temperature increases in the course of the reaction and the temperature in the vicinity of the mold surface reaches the expansion start temperature, the curing reaction proceeds close to the surface of the molded resin and the pressure close to the surface is increased by the internal expansion. As a result, almost no expansion of the microspheres occurs in the vicinity of the surface of the molded resin, and therefore a layer containing substantially no expanded microspheres is formed on the surface of the molded resin (this layer is sometimes referred to hereinbelow as the “non-expansion layer”).

Because the formation of the non-expansion layer depends on the initial mold temperature and the expansion start temperature of the thermally expandable microspheres, the non-expansion layer can be formed uniformly at the surface of the molded resin that is in contact with the mold, regardless of the molded resin shape. The inventors have observed that the non-expansion layer is formed to a thickness of about 50-500 μm from the surface of the molded resin, and it contains very few, if any, expanded microspheres. To the extent there are any microspheres, they are of extremely small size, e.g., on the order of several to several tens of microns in diameter. Due to the presence of this non-expansion layer, the molded resin product formed according to the above-described process has a dense and smooth surface having no pinholes or the like, and it excels in surface hardness and mechanical properties.

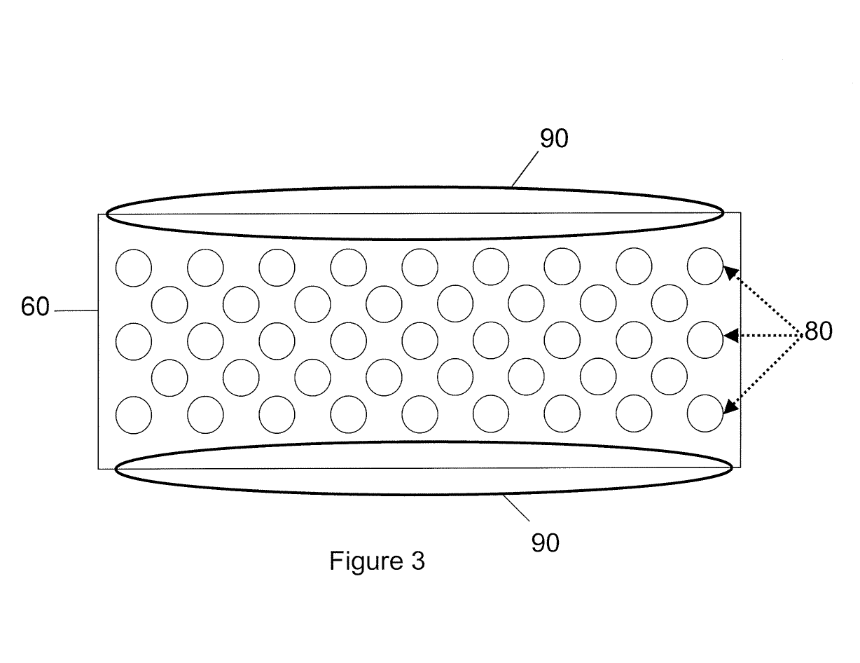

FIG. 3 is a depiction of a cross-section of a molded resin product 60 formed using the process of FIG. 2. The expanded microspheres 80 are formed by hollow balloons of thermally expandable microspheres having similar diameters. Accordingly, the expanded microspheres 80 have a substantially uniform size, preferably a diameter of 100 μm or less, which can be selected based on the expansion factor and the pre-expansion size of the microspheres added to the liquid resin component(s). Also, each expanded microsphere is formed independently of the others, and therefore the molded resin contains substantially no continuous expanded microspheres that are connected to each other. The uniform size of the expanded microspheres and the closed-cell structure provide a molded resin with superior mechanical properties as compared to conventional molded resins such as a dicyclopentadiene foamed molded resin produced by using a dissolved gas, chemical foaming agent, or the like.

Further, as indicated by the circled regions 90, there is a layer near at least one surface (and preferably both) that contains substantially no expanded microspheres, which provides an improved surface appearance. In particular, in a molded resin product formed using the process of FIG. 2, the expansion of the thermally expandable microspheres proceeds from the inside of the molded resin towards the surface. The pressure induce by the expansion is therefore applied toward the surface of the molded resin, i.e., the surface contacting the mold. As a result shrinkage cavities and filling defects are prevented effectively, regardless of the thickness or shape of the molded resin. Thus, the molded resin has improved mechanical properties and can be formed with stable dimensions even when a complex mold design is used, and the surface has no pin defects, partially expanded microspheres, etc.

The average size of the expanded microspheres in accordance with the present invention is the average value of diameters of cross-sections of expanded microspheres observed under a microscope such as an electron microscope with a magnification of 100-200, where the observed sample is taken by cross-cutting the molded resin in the thickness direction of the crosslinked polymer. Those skilled in the art that the size of the cross-section of the expanded microspheres observed in the cross-cut sample is not necessarily the diameter of the expanded microspheres. This is because the microspheres are spherical. A variety of cross-sections of a sphere may be obtained that do not reveal the exact diameter of the sphere unless the cross-section is taken directly through the center of the sphere. Assuming that all of the expanded microspheres are spheres of substantially the same size, the average diameter of cross-sections observed in random cutting can be calculated as a diameter of a sphere multiplied by a factor of about 0.74. As described herein, however, the inventors have not strictly taken this factor into account and have not performed any correction in accordance with the 0.74 factor. Instead, the inventors have calculated the average size of expanded microspheres as a simple average of the diameters of the cut surfaces observed in a cross-cut sample under a microscope, as described above.

### SPECIFIC EXAMPLES OF THE PREFERRED EMBODIMENTS

Specific examples of preferred embodiments are provided below to further illustrate aspects of the present invention. Those skilled in the art will appreciate that there are numerous other variations that can be formulated based on the teachings of this specification, and the examples below are not intended to limit the scope of the present invention.

In the following examples, the mixed reaction monomer, activator, and catalyst are prepared as follows:

(Preparation of Mixed Reaction Monomer)

A total weight of 3.5 parts by weight of ethylene-propylene-ethylidene norbornene co-polymer rubber is dissolved into a solution consisting of 91.5 parts by weight of high-purity dicyclopentadiene (purity 99.7 wt. %) and 5 parts by weight of ethylidene norbornene (purity 99.5 wt. %).

(Preparation of Activator)

Trioctylaluminum and diglyme were mixed in a molar ratio of 100:100.

(Preparation of Catalyst)

18 parts by weight of tungsten hexachloride was added to 39 parts by weight of dry toluene under a nitrogen atmosphere and then a solution consisting of 0.8 parts by weight of t-butanol and 0.8 parts by weight of toluene was added. The solution was purged with nitrogen overnight to remove hydrogen chloride gas formed by the reaction of tungsten hexachloride with t-butanol. Then a solution consisting of 12 parts by weight of nonylphenol and 3 parts by weight of toluene was added to the above solution. The mixed solution was purged with nitrogen overnight to remove hydrogen chloride gas formed by the reaction of the tungsten complex with nonylphenol. Then, 8 parts by weight of acetylacetone was added. The solution was purged with nitrogen overnight to remove hydrogen chloride gas formed by the reaction of the tungsten complex with acetylacetone. The resulting solution was used as the catalyst for polymerization.

### Example 1

(Preparation of Component A)

A total weight of 1.2 parts by weight of activator was mixed into 100 parts by weight of the mixed monomer.

(Preparation of Component B)

A total weight of 2.3 parts by weight of the catalyst was mixed into 100 parts by weight of the mixed monomer.

(Preparation of Component C)

A total weight of 3 parts by weight of thermally expandable microspheres ADVANCELL EM EHM301 (manufactured by Sekisui Chemical Industries Co., Ltd., referred to hereinbelow as “EHM301”) was mixed into 100 parts by weight of the mixed monomer. The EHM301 has an expansion start temperature in the range of 140-150° C., and an average pre-expansion diameter of 23-29 μm.

(Molding)

Component A, Component B, and Component C were mixed by a mixing head with a volume ration of 1:1:1 and were injected into a mold. A mold for plaques was used having a length of 250 mm, a width of 250 mm, and a thickness of 3 mm. The mold temperature was 90° C. on the cavity side and 50° C. on the core side. The pressure inside the mold was maintained at 0.05 MPa during the molding.

(Evaluation)

The condition of the back surface (i.e., core-side surface) of the obtained molded resin plaques contained no visible cavities and the surface condition appeared good. The surface condition of the obtained molded plaques was designated by the symbol ◯. (In evaluating the surface condition of the molded resin products produced by the other Examples and Comparative Examples described below, the three symbols [symbol] , ◯, and x are used, respectively, to indicate whether the observed surface condition is better than, the same as, or worse than the surface condition of the molded plaques in this example.) The molded plaques were cut to appropriate sizes to measure mechanical properties such as specific gravity, impact strength, tensile strength, tensile modulus, flexural strength, and flexural modulus. The measurements of these mechanical properties are presented in Table I.

### Example 2

(Preparation of Component A)

A total weight of 0.8 parts by weight of the activator was mixed into 100 parts by weight of the mixed monomer.

(Preparation of Component B)

A total weight of 1.5 parts by weight of the catalyst and 0.5 parts by weight of EHM301 were mixed into 100 parts by weight of the mixed monomer.

(Molding and Evaluation)

Component A and Component B were mixed in the mix head with a volume ration of 1:1 and injected into a mold. A mold for plaques was used having a length of 250 mm, a width of 250 mm, and a thickness of 3 mm. The mold temperature was 90° C. on the cavity side and 50° C. on the core side. The pressure inside the mold was maintained at 0.05 MPa during the molding.

Data regarding the observed surface condition and the measured mechanical properties is presented in Table I.

### Example 3

(Preparation of Component A)

A total weight of 0.8 parts by weight of the activator and 0.5 parts by weight of EHM301 were mixed into 100 parts by weight of the mixed monomer.

(Preparation of Component B)

A total weight of 1.5 parts by weight of the catalyst and 0.5 parts by weight of EHM301 were mixed into 100 parts by weight of the mixed monomer.

(Molding and Evaluation)

Plaques were molding using Component A and Component B under the same molding conditions as Example 2. Data regarding the observed surface condition and the measured mechanical properties is presented in Table I.

### Example 4

The same Component A and Component B were used as in Example 3. Plaques were molded using the same molding conditions as in Example 2, except that the cavity-side mold temperature was 90° C. and the core-side mold temperature was 80° C. The core-side surface (back side) of the obtained plaques was observed to be as absolutely flat and smooth as the cavity-side surface (front side). Data regarding the observed surface condition and the measurements of mechanical properties is provided in Table I.

### Comparative Example 1

(Preparation of Component A)

A total weight of 0.8 parts by weight of the activator was mixed into 100 parts by weight of the mixed monomer.

(Preparation of Component B)

A total weight of 1.5 parts by weight of the catalyst was mixed into 100 parts by weight of the mixed monomer.

(Molding and Evaluation)

Prior to molding, nitrogen gas in an amount of 0.08 wt. % was dissolved into each of Component A and Component B. Plaques were then formed using the same molding conditions as Example 2. Data regarding the observed surface condition and the measured mechanical properties is presented in Table I.

### Comparative Example 2

Component A and Component B were prepared in the same manner as described above for Comparative Example 1. Prior to molding, nitrogen gas in an amount of 0.02 wt. % was dissolved into each of Component A and Component B. Plaques were then formed using the same molding conditions as Example 2. A number of spot-like and stripe-like cavities were observed at the peripheral portions of the core-side surface. Data regarding the observed surface condition and the measured mechanical properties is presented in Table I.

### Comparative Example 3

Component A and Component B were prepared in the same manner as described above for Comparative Example 1. No nitrogen gas was dissolved in the components. Plaques were formed using the same molding conditions as Example 2. A large number of spot-like and stripe-like cavities were observed in the core-side surface. Data regarding the observed surface condition and the measured mechanical properties is presented in Table I.

### Table I

Cross-sections of the exemplary molded resin plaques were made following measurement of the mechanical properties. The cross-sections were observed using a scanning electron microscope (SEM) having a magnification ratio of 50, and a non-expansion layer with a thickness of about 200-300 μm was observed (i.e., a layer at the surface of the foamed molded resin that contained substantially no expanded microspheres). Further, the expanded microspheres observed within the inner foamed layer had a closed-cell structure and an average expanded size of 100 μm or less. No expanded microspheres with an open-cell structure and no extremely large expanded microspheres were observed.

The above-described results and the data in Table I illustrate that a foamed molded resin product formed in accordance with the present disclosure has mechanical properties superior to those obtained using dissolved nitrogen gas as a foaming agent. Thus, it is clear that a molded resin product can be obtained practically without the need for expensive equipment and yet without losing the mechanical properties inherent to a resin. Further, a molded resin product can be obtained that has a flat and smooth surface that is free from shrinkage cavities on the core-side surface of the molded resin (in addition to a smooth surface on the cavity-side surface).

Accordingly, the above-described liquid resin and process can be used to make a molded resin product that has a lower specific gravity (and therefore is reduced in weight), has a smooth surface on both surfaces (core mold side and cavity mold side) and has good mechanical properties, without the need for expensive equipment.

While the invention has been described above by way of examples and preferred embodiments, those skilled in the art will recognize that there are other variations of the above-embodiments. The scope of the invention is not intended to be limited to the specific examples and embodiments presented above, but rather should be determined by reference to the claims appended hereto.

We claim:

1. A liquid molding resin component for use in a reaction injection molding process, the liquid molding resin component comprising:
a liquid resin reaction monomer comprising dicyclopentadiene; and
a plurality of thermally expandable microspheres,
wherein the plurality of thermally expandable microspheres have an expansion start temperature in a range of about 120° C. to about 160° C.

2. A liquid molding resin component according to claim 1, wherein the thermally expandable microspheres have a core-shell structure in which the core comprises a low-boiling hydrocarbon and the shell comprises a thermoplastic polymer.

3. A liquid molding resin component according to claim 1, wherein the thermally expandable microspheres have a maximum expansion temperature of about 150° C. or higher.

4. A liquid molding resin component according to claim 1, further comprising one of (i) an activator including an alkylaluminum compound and (ii) a catalyst including at least one of a tungsten compound and a molybdenum compound.

5. A liquid molding resin component according to claim 1, wherein the thermally expandable microspheres have an average unexpanded diameter in a range of about 10 μm to about 50 μm.

6. A liquid resin component system for use in a reactive injection molding process, said component system comprising a plurality of liquid resin components, wherein each of the liquid resin components includes a reaction monomer comprising dicyclopentadiene, wherein at least one of the liquid resin components includes a catalyst and at least one of the liquid resin components includes an activator, and wherein at least one of the liquid resin components includes thermally expandable microspheres having an expansion start temperature in the range of about 120° C. to about 160° C.

7. A liquid resin component system according to claim 6, wherein the thermally expandable microspheres have a core-shell structure in which the core comprises a low-boiling hydrocarbon and the shell comprises a thermoplastic polymer.

8. A liquid resin component system according to claim 6, wherein the activator includes an alkylaluminum compound and the catalyst includes at least one of a tungsten compound and a molybdenum compound.

9. A liquid resin component system according to claim 6, wherein the microspheres are present in an amount such that the microspheres constitute from about 0.1 to about 5 parts by weight of the total liquid resin.

10. A method of making a liquid resin component for use in an injection molding process, said method comprising the steps of:
providing a liquid resin reaction monomer comprising dicyclopentadiene;
adding thermally expandable microspheres to the liquid resin reaction monomer, wherein the thermally expandable microspheres have an expansion start temperature in the range of about 120° C. to about 160° C.

11. A method according to claim 10, wherein the thermally expandable microspheres have a core-shell structure in which the core comprises a low-boiling hydrocarbon and the shell comprises a thermoplastic polymer.

12. A method according to claim 10, wherein said thermally expandable microspheres have an average unexpanded diameter in a range of about 10 μm to about 50 μm.

13. A method according to claim 10, further comprising a step of adding an activator including an alkylaluminum compound to the liquid resin reaction monomer.

14. A method according to claim 10, further comprising a step of adding a catalyst including at least one of a tungsten compound and a molybdenum compound to the liquid resin reaction monomer.

15. A method of making a molded resin product, the method comprising the steps of:
providing a plurality of liquid resin components that each include a reaction monomer for a resin, wherein at least one of the liquid resin components includes a catalyst, at least one of the liquid resin components includes an activator, and at least one of the liquid resin components includes thermally expandable microspheres;
mixing the liquid resin components; and
injecting the mixed liquid resin components into a mold at a predetermined temperature,
wherein the predetermined temperature is at least 10° C. lower than an expansion start temperature of the thermally expandable microspheres.

16. A method according to claim 15, wherein the predetermined temperature is at least 30° C. lower than the expansion start temperature of the thermally expandable microspheres.

17. A method according to claim 15, wherein the thermally expandable microspheres have an average diameter, after expansion, of about 100 μm or less.

18. A method according to claim 15, wherein the thermally expandable microspheres are provided in an amount with a range of about 0.1 to about 5 parts by weight based on a total amount of 100 parts by weight of the liquid resin.

19. A method according to claim 15, wherein the reaction monomer includes dicyclopentadiene and wherein the expansion start temperature of the thermally expandable microspheres is in the range of about 120° C. to about 160° C.

20. A method according to claim 19, wherein the thermally expandable microspheres have an average diameter, after expansion, of about 100 μm or less and wherein the thermally expandable microspheres are provided in an amount with a range of about 0.1 to about 5 parts by weight based on a total amount of 100 parts by weight of the liquid resin.

21. A method according to claim 15, wherein the thermally expandable microspheres are included in a liquid resin component that does not contain either a catalyst or an activator.

22. A molded resin product formed by a method comprising the steps of:
providing a plurality of liquid resin components that each include a reaction monomer for a resin, wherein at least one of the liquid resin components includes a catalyst, at least one of the liquid resin components includes an activator, and at least one of the liquid resin components includes thermally expandable microspheres;
mixing the liquid resin components; and
injecting the mixed liquid resin components into a mold at a predetermined temperature,
wherein the predetermined temperature is at least 10° C. lower than an expansion start temperature of the thermally expandable microspheres.

23. A product according to claim 22, wherein the reaction monomer is dicyclopentadiene, the expansion start temperature of the microspheres is in a range from about 120° C. to about 160° C., and the expanded microspheres have an average diameter of about 100 μm or less.

24. A product according to claim 23, wherein the product has a layer near at least one surface that contains substantially no expanded microspheres.
